(19) United States
(12) Patent Application Publication
(10) Pub. No.: US 2013/0022792 A1
(43) Pub. Date: Jan. 24, 2013

(54) Silicone-Elastomer Film

(71) Applicant: Fred A. Antonini, Fort Worth, TX (US)

(72) Inventor: Fred A. Antonini, Fort Worth, TX (US)

(21) Appl. No.: 13/622,198

(22) Filed: Sep. 18, 2012

Related U.S. Application Data
(63) Continuation-in-part of application No. 10/523,942, filed on Feb. 8, 2005, now Pat. No. 8,268,426.
(60) Provisional application No. 60/500,311, filed on Sep. 4, 2003.

(51) Int. Cl. B32B 27/08; B32B 3/30; B32B 27/00

(52) U.S. Cl. 428/172; 428/343; 428/411.1

(57) ABSTRACT

A film includes a dimensionally stable plastic film with a layer of elastic material applied to a first surface of the plastic film. An adhesive is applied to an opposing second surface of the plastic film. The film is adhesively bonded to an object and prevents slipping of an object relative to a structure via the elastic material.

### CROSS REFERENCE TO RELATED APPLICATIONS

This application is a continuation-in-part of U.S. application Ser. No. 10/523,942, filed 8 Feb. 2005, titled “Silicone-Elastomer Film,” which claims the benefit of International PCT Application No. PCT/US04/06552, filed 3 Mar. 2004, titled “Silicone-Elastomer Film and Method of Manufacturing Same,” which claims the benefit of Provisional Application No. 60/500,311, filed 4 Sep. 2004, titled “Method and Apparatus for Bonding Liquid Silicone Rubber to Polyester Film,” all of which are hereby incorporated by reference for all purposes as if fully set forth herein.

### BACKGROUND

1. Field of the Invention

The present invention relates to thin film silicone elastomers and methods of manufacturing thin film silicone elastomers.

2. Description of Related Art

Most handheld electronic devices, such as cellular telephones, camcorders, cameras, computer-based digital cameras, CD and MP3 players, PDA's, remote controls, notebook computers, tablet PC's, video games, video game controllers, hair trimmers and shears, and a wide variety of other handheld electronic devices, including carrying cases and pouches for these devices, have housings that are made of hard, smooth materials, such as plastic and metal. Although some of these devices include hand grips and/or small rubberized components, they typically do not include any anti-slip material over a large portion of their housings. This is a problem, because when a user handles one of these devices, the slightest amount of mishandling can allow the device to slip out of the user's hand, which can lead to the device being dropped and damaged. In addition, when these devices are placed on a table or other surface, such as the dashboard of a vehicle, they are vulnerable to sliding or being knocked off onto the floor or ground, which can lead to breakage or permanent damage.

Most handheld electronic devices have housings that are made of hard, smooth plastic or metal. The front faces of these housings usually include ornamental shapes and designs, but the rear faces are typically plain and smooth. Often, the rear, side, and bottom surfaces include switches, buttons, and access ports for receiving interchangeable components, batteries, and carrying cases. These switches, buttons, and access ports leave exposed joints, seams, and grooves. Flip-type and swivel telephones also include integral plastic and metal hinges and swivels.

In addition, many of these handheld electronic devices are configured to fit on top of other components or into accessory components, such as caddies, cradles, chargers, docking stations, computer monitors, carrying cases, and clips. When coupled together, there is usually very little clearance between the device and the accessory component. As a result, it is not possible to place a thick, anti-slip material directly onto the device, as doing so would prevent or impede the device from properly mating with its accessory component.

In addition to adding anti-slip functionality to handheld electronic devices, there are many other applications in which anti-slip functionality is desired. For example, in the printing industry, it is desirable to have rollers and other paper handling components that have high gripping capacity and that are highly durable. There are countless other material handling examples across many other industries in which it is desirable to have durable, anti-slip functionality.

Also, many applications exist in the sport and recreation industries. For example, many sports require the use of handheld equipment, such as bats, rackets, paddles, sticks, and other devices with gripping surfaces. In these sports, it is usually desirable to have anti-slip functionality associated with this equipment. In addition to handheld equipment, there are many sporting and recreation applications in which it is desirable that there be anti-slip functionality between a users clothing and his equipment.

Although there have been significant developments over the years in the area of producing thin elastomers, considerable shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a perspective view of a film of the present invention;

FIG. 2 is a side view of a film according to the invention;

FIG. 3 is an enlarged view of a section of the film of FIG. 1, the surface texture being visible;

FIG. 4 is a side view of a second embodiment of the film of the present invention, the film having an adhesive layer added;

FIG. 5 is a side view of a third embodiment of the film of the present invention, the film having adhesive layers and a label stock added;

FIG. 6 is a side view schematically illustrating the method used to manufacture the film of FIG. 1;

FIG. 7 is a perspective view of a handheld electronic device, the device having films of the present invention applied to outer surfaces of the device for use as anti-slip skins;

FIG. 8 is a front view of a ping-pong paddle having a film of the present invention applied to the striking surface of the paddle;

FIG. 9 is a front view of a hand having films of the present invention applied to the fingertips for use as anti-sip skins;

FIGS. 10A and 10B are side views of a film according to an alternative embodiment of the present application;

FIG. 11 is a side view schematically illustrating the method to manufacture the film of FIG. 10B; and

FIGS. 12-14 depict surface treatments applied to the film of FIG. 10B.

While the system and method of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

While the making and using of various embodiments of the present invention are discussed in detail below, it will be appreciated that the present invention provides many applicable inventive concepts that can be embodied in a wide variety of specific contexts. The specific embodiments discussed herein are merely illustrative of exemplary ways to make and use the invention, and do not limit the scope of the invention. It should be noted that the layers in the figures are not drawn to scale.

The present invention is directed to a thin, soft, silicone elastomer film for use as an anti-slip skin, or applique. The skin can be applied, adhered, sewn, or otherwise attached to objects, a person's skin, the clothing of a user, or placed between objects, all of which act to prevent or reduce undesired relative motion between adjacent objects.

According to the present invention, a silicone elastomer is bonded to a thin, dimensionally stable plastic film substrate to form a flexible, thin film, referred to herein as a “silicone-elastomer film.” It has been found that the use of a silicone material having a low-durometer, i.e., less than 40 on the Shore A scale, and a dimensionally stable, smooth, plastic film having a surface energy of about 40 Dynes/cm, provides the best results. It will be appreciated that many thin plastic films are not dimensionally stable. This configuration overcomes many of the problems associated with thin elastomeric sheets. For example, with the silicone-elastomer film of the present invention, the silicone elastomer is stabilized and prevented from “stretching” and sliding off the surface to which it is applied. In addition, an inexpensive acrylic pressure sensitive adhesive may be used to bond the silicone-elastomer film to other surfaces.

The silicone-elastomer film is durable, resilient, and capable of adhering to a suitable acrylic pressure sensitive adhesive. In the preferred embodiment of the present invention, the silicone elastomer is applied to the plastic film. Then, a textured and polished surface finish is imparted to the silicone elastomer by a casting means having a polished surface finish. This process creates a textured and polished surface finish on the silicone elastomer. The phrase “surface finish” will be used herein to describe the surface of materials on a very fine, or microscopic, scale; whereas the phrase “surface texture” will be used to describe the surface of materials on a larger scale, i.e., to indicate the presence of raised bumps, dimples, or ridges that can be seen with the naked eye and felt by hand.

The production of a silicone elastomer with a polished and textured surface finish represents a significant discovery in the present invention. It has been found that the use of such a silicone elastomer greatly improves the performance characteristics of the silicone-elastomer film. An equally important discovery in the present invention is the production and use of the thin, dimensionally stable, smooth plastic film substrate. These discoveries provide significant benefits, including: (1) the casting means releases cleanly from the silicone elastomer after curing; (2) the silicone elastomer is significantly more “grippy,” i.e., has a higher coefficient of friction with more anti-slip functionality; and (3) the silicone elastomer is resistant to collecting dust and debris.

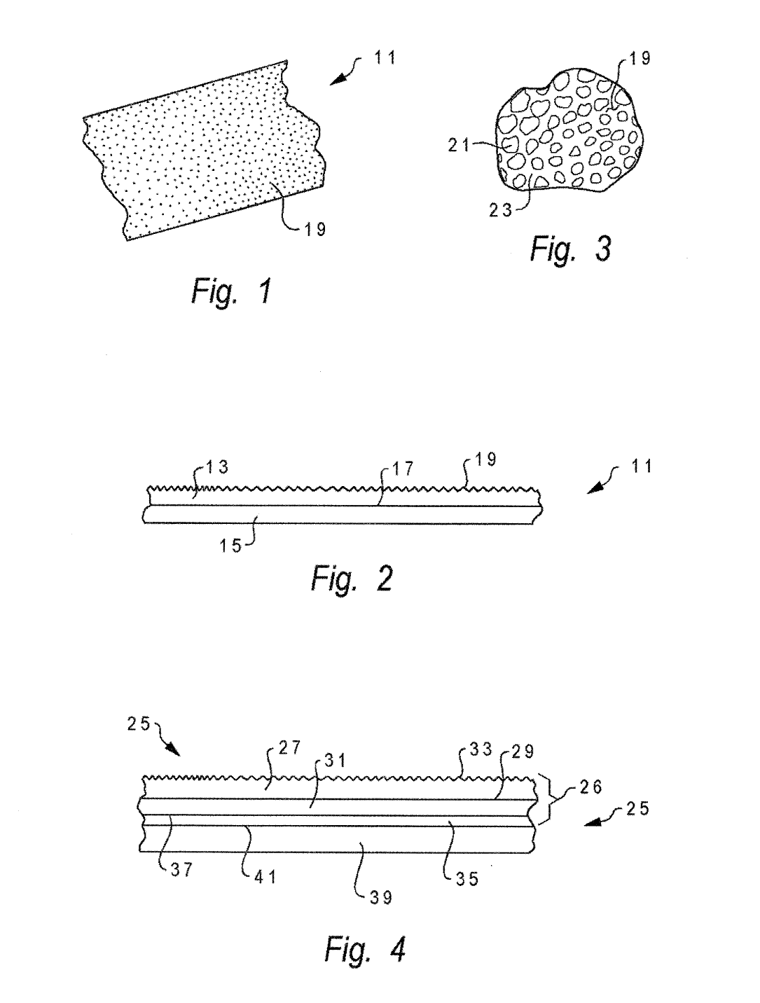

Referring to FIGS. 1 through 3 in the drawings, the preferred embodiment of a silicone-elastomer film 11 according to the present invention is illustrated. As shown in FIG. 1, film 11 is formed as a sheet, and may be formed as a continuous sheet on a roll (not shown). FIG. 2 is a side view of film 11 showing a two-layer construction of film 11, in which a layer of silicone elastomer 13 having an exposed surface 19 with a polished surface finish is disposed on an upper surface 17 of a thin plastic film substrate 15. FIG. 3 is an enlarged view showing the pattern of the surface texture shown in FIGS. 1 and 2, with upraised bubble-shaped dimples 21 being separated by narrow valleys 23.

As explained above, the textured and polished surface finish of silicone-elastomer film 11 is preferably formed by a casting means, such as a casting film, having a polished surface finish. It will be appreciated that the surface finish of surface 19 of silicone elastomer 13 may also be formed by other means, such as tools, dies, or rollers; provided that such means imparts, imprints, or transfers, the desired textured and polished surface finish to silicone elastomer 13. Surface 19 is preferably formed to have a surface texture or pattern, as shown, although surface 19 may alternatively be matte or smooth. It has been found that, in some instances, the surface texture of surface 19 does not contribute significantly to the anti-slip functionality of film 11; however, certain surface textures do hide imperfections in film 11 and prevent dust and debris, which are easily seen on matte and smooth surfaces, from collecting on surface 19. This improves the look and feel of silicone-elastomer film 11.

Plastic film substrate 15 is a thin, flexible film, preferably a clear film about 0.002 inches thick, that forms and provides a flexible, durable, dimensionally stable substrate. It is preferred that plastic film 15 have a smooth surface finish, as may be attained with a co-extrusion process, and have a surface energy lower than about 40 Dynes/cm. This combination ensures a strong bond between plastic film 15 and silicone elastomer 13. This unique bond prevents silicone elastomer 13 from easily being detached from plastic film 15 during manufacture and use of film 11. For aesthetic purposes, plastic film 15 and/or silicone elastomer 13 may be tinted or may include embedded or printed graphical indicia. It is preferred that the combined thickness of silicone-elastomer film 11 be no greater than about 0.032 inches.

Silicone elastomer 13 is formed to have a low-durometer, i.e., less than 40 on the Shore A scale. This, along with the inherent bonding characteristics of silicone materials, facilitates bonding with plastic film 15. Silicone 13 may be applied to plastic film 15 by pouring, spraying, spreading, doping, or any other conventional application means suitable for applying a silicone material to solid sheets or films. However, as described below, the preferred method of applying silicone elastomer 13 to plastic film 15 is by controlled pouring in a continuous production process in which silicone elastomer 13 is sandwiched between plastic film 15 and a casting means having a textured and polished surface finish.

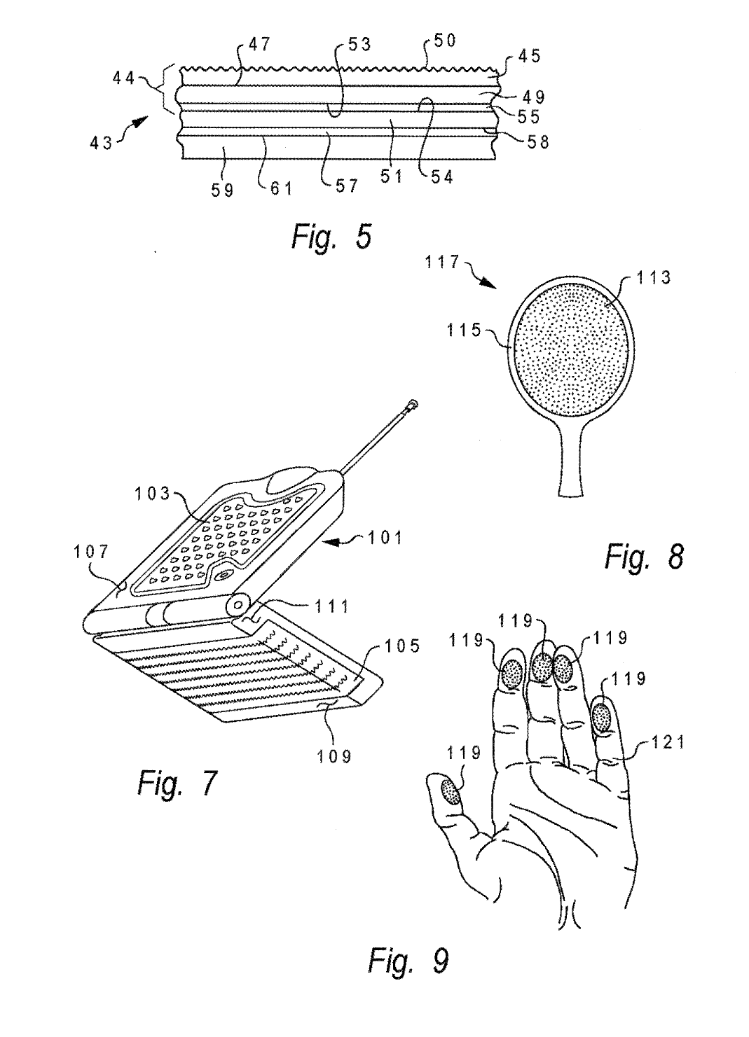

Referring now to FIG. 4 in the drawings, an alternative embodiment of the film of the present invention is illustrated. In this embodiment, a film 25 has an upper portion 26 that has the same construction as film 11 described above, in that a silicone elastomer 27 is applied onto an upper surface 29 of plastic film 31. As such, silicone elastomer 27 has an exposed surface 33 with a textured and polished surface finish. To provide a means of affixing film 25 to an object, a layer of adhesive 35 is applied to a lower surface 37 of plastic film 31, and a release liner 39 is placed against surface 41 of adhesive 35 for preventing contamination or setting of adhesive 35 prior to installation of film 25. Plastic film 31 provides a suitable base for which to bond adhesive layer 35, as it has been found that it is difficult to obtain a durable bond directly between adhesives and cured silicone materials. Adhesive 35 may be applied as a tape by other appropriate means, such as in liquid form. Prior to use, release liner 39 is removed from adhesive 35, allowing film 25 to be adhered to a surface.

Referring now to FIG. 5 in the drawings, a second alternative embodiment of the film of the present invention is illustrated. In this embodiment, a film 43 has an upper portion 44 that has the same construction as film 11 described above, in that a silicone elastomer 45 is applied onto an upper surface 47 of a plastic film 49. As such, silicone elastomer 45 has an exposed surface 50 with a textured and polished surface finish. A label stock 51, which may include graphical and/or textual indicia or other desired items, is adhered to a lower surface 53 of plastic film 49 by applying an adhesive layer 55 to an upper surface 54 of label stock 51. This allows any graphical indicia on label stock 51 to be visible through silicone elastomer 45 and plastic film 49. To allow for application of film 43 to a surface, a second adhesive layer 57 is applied to a lower surface 58 of label stock 51, and a release liner 59 is applied onto a lower surface 61 of adhesive layer 57.

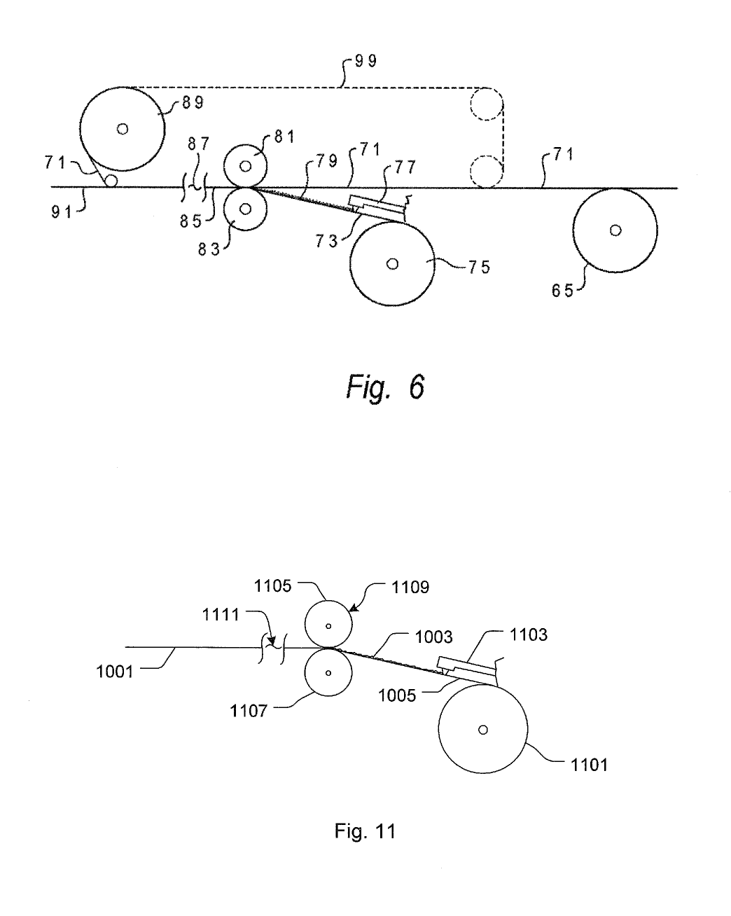

Referring now to FIG. 6 in the drawings, the preferred method of manufacturing a silicone-elastomer film 91 according to the present invention is schematically illustrated. The first step in the process is to form or provide a casting means, such as a casting film 71, that is adapted to transfer a textured and polished surface finish to the silicone elastomer. Casting film 71 may be formed by a wide variety of conventional means for forming such films. The production of casting film 71 may be an integral part of the process of manufacturing silicone-elastomer film 11, or casting film 71 may be produced in a separate process prior to use in an off-site facility and stored in sheets or rolls 65. This allows casting film 71 to endure the heat of the curing process described below without undergoing any undesirable changes in shape, dimensions, or composition.

Casting film 71 is conveyed toward one or more nipping, or pinch, rollers 81, 83. At the same time, a plastic film substrate 73, which is preferably stored in a roll 75, is also conveyed toward nipping rollers 81, 83. Due to the thinness of plastic film 73, it is preferred that plastic film 73 be heat stabilized prior to use. This heat stabilization ensures that plastic film 73 can endure the heat cycle of the curing process without cockling or buckling. This prior heat stabilization of plastic film 73 is not typical of plastic films.

Before casting film 71 and plastic film 73 are drawn through nipping rollers 81, 83, a volume of silicone elastomer 79 is disposed on the upper surface of plastic film 73, preferably in liquid form by a nozzle 77, or a similar device. Then, plastic substrate 73, casting film 71, and silicone elastomer 79 are drawn between nipping rollers 81, 83. This causes silicone elastomer 79 to spread evenly at a selected thickness over plastic film 73 and transfers the textured and polished surface finish of casting film 71 to the exposed surface of silicone elastomer 79. This nipping process forms a film assembly 85 that is then subjected to a curing process, which is indicated by area 87 in the FIG. 6. Curing process 87 may include raised temperatures and pressures for varying durations of time. The specific temperatures, pressures, and cure times may vary depending upon the specific characteristics that are desired in the final film. It will be appreciated that other layers of materials, such as adhesives, label stocks, and release liners, may also be combined with film assembly 85, and that these other layers may be added before or after curing process 87.

Next, casting film 71 is removed from film assembly 85 and captured on roller 89, leaving a completed silicone-elastomer film 91 having a textured and polished surface finish according to the present invention. Once manufactured in sheet form, silicone-elastomer film 91 may be configured for a wide variety of uses and applications, by cutting, shaping, and other post-processing steps.

In an alternative method of manufacture, casting film 71 is reused after it is removed from film assembly 85. This embodiment is represented by the phantom lines in FIG. 6. In this embodiment, a film return loop 99 is provided so that casting film 71 may be returned to a location in the process prior to passage through nipping rollers 81, 83.

The production method shown in the figures and described above is only one example of a configuration for manufacturing the silicone-elastomer films 91 according to the present invention. The feed paths of casting film 71 and plastic film 73 may be configured in a variety of ways to achieve the same results. For example, the positions of the feed paths of casting film 71 and plastic film 73 may be reversed, with silicone elastomer 79 being applied to casting film 71, rather than plastic film 73, prior to nipping rollers 81, 83. Another possible configuration has the feed paths of casting film 71 and plastic film 73 in generally vertical orientations.

Referring now to FIGS. 7 through 9 in the drawings, some possible uses of the silicone-elastomer film of the present invention will now be described with respect to the configuration of FIG. 4. Because silicone-elastomer film 25 is typically formed as a sheet, a user may cut or otherwise shape portions of the sheet to create desired shapes and sizes of film 25. The user then removes release liner 39 from adhesive 35, and applies each film 25 to a selected surface. Film 25 then acts as an anti-slip applique for preventing or reducing movement of the selected surface relative to an adjacent surface.

In FIG. 7, a handheld electronic device 101, in this instance a mobile telephone, onto which silicone-elastomer films 103, 105 are adhesively affixed for use as anti-slip skins, is shown. Skin 103 is applied to an outer surface 107 of device 101, and skin 105 is applied to outer surfaces 109, 111. The outer surface of each skin 103, 105 is preferably formed to have a bubble pattern texture and polished surface finish, as shown in FIG. 3 and described above. Skins 103, 105 provide anti-slip functionality when device 101 is placed against other objects or surfaces because the exposed silicone material of skins 103, 105 grips the adjacent surfaces.

In FIG. 8, a silicone-elastomer film 113 according to the present invention is shown applied to the striking surface 115 of a ping-pong paddle 117. Silicone-elastomer film 113 ensures a good lateral grip between paddle 117 and a ball (not shown) struck by the paddle, thereby enhancing the ability of the user to impart spin on the ball when striking the ball. It will be appreciated that the silicone-elastomer films of the present invention may be used on a wide variety of sporting equipment and in a wide variety of recreational applications.

In FIG. 9, a silicone-elastomer film 119 is shown in another use. Film 119 has been configured into small shapes for application to a user's fingertips 121. This provides for high levels of grip between fingertips 121 and objects being manipulated by the user. For example, films 119 may be used to allow the user to more easily pull sheets of paper from a stack, or to count money. An advantage of using films 119 in this application is that fingertips 121 are not fully enclosed, as with thimble-type fingertip appliances. This allows the user's fingers to “breathe,” and prevents the user from feeling discomfort from heat buildup around fingertips 121.

The potential applications of the present invention go far beyond the uses mentioned above. The silicone-elastomer film according to the present invention may be used in many different applications across a wide variety of industries, particularly when configured, cut, shaped, and formed for specific applications. For example, the present invention may also be used as follows: (1) as an outer surface of a sleeve for a printer roller or other paper handling equipment; (2) as a self adhesive “hand pad” for weight lifters; (3) as a grip for flashlights; (4) as pads for eyeglass nosepieces; (5) as strips to be applied to the bottom of tool trays to keep tools from sliding; (6) as “barefoot” footwear; and (7) as an anti-slip skin for medical devices.

In other applications, the film according to the present invention can be used as an applique for, or sewn into, uniforms, clothing, or gear. For example, in motocross, when riders grip their handlebars for long periods of time, their hands and arms become fatigued. The film of the present invention may be placed on the riders pants to allow the rider to periodically grip the motorcycle with his legs. This helps relieve the fatigue in the rider's hands and arms. It will be appreciated that the present invention has additional applications in the motocross industry.

In an alternate embodiment, the silicone elastomer is disposed on both sides of the plastic film. This can be done, for example, by either coating both sides of the plastic film, or by adhering two silicone-elastomer films together back to back. This configuration allows for anti-slip functionality on both sides of the silicone-elastomer film, and allows the use of the present invention in applications in which it is undesirable to adhere the silicone-elastomer film directly to an object.

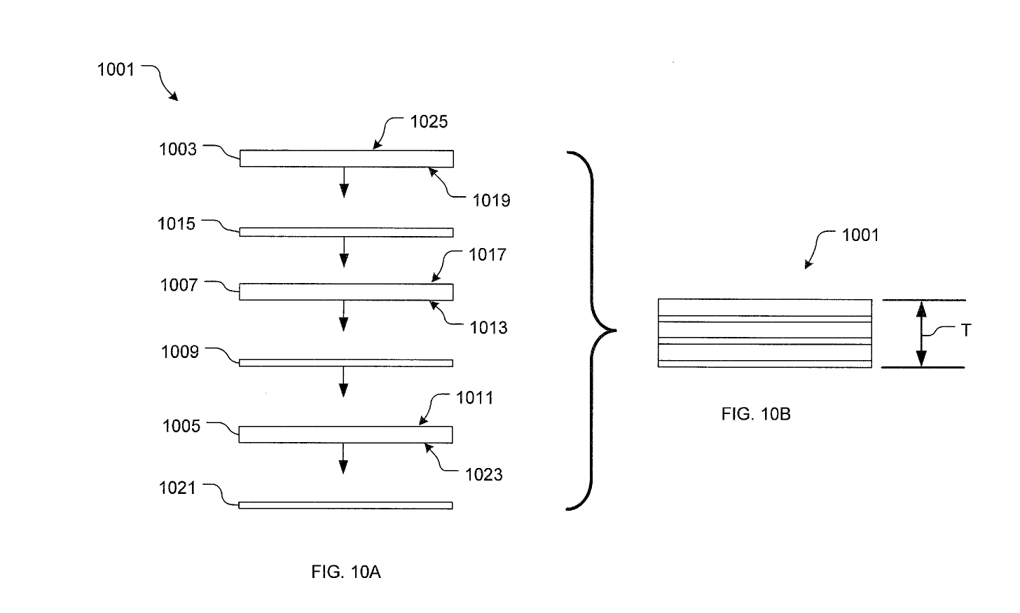

Referring now to FIGS. 10A and 10B in the drawings, side views of a film 1001 are shown according to an alternative embodiment of the present application. FIG. 10A depicts a disassembled view of the different layers of material associated with film 1001, while FIG. 10B depicts an assembled view of film 1001. It should be understood that film 1001 is substantially similar in form and function to the silicone-elastomer films discussed above, and it will be appreciated that one or more features associated with these alternative embodiments could easily be incorporated with film 1001, and vice-versa.

Film 1001 satisfies a long-felt need associated with current silicone-elastomeric films. Specifically, film 1001 includes an upper layer that is composed of elastic material adapted to reduce slipping, as discussed above, yet is sufficiently formable during the manufacturing process to eliminate the use of a casting film. This feature greatly reduces the costs associated with manufacturing elastomeric films. It will be appreciated that the elastic material allows for sufficient elastic deformation as a force is applied thereagainst, but yet retains sufficient rigidity to resist slipping and return back to its original shape thereafter. In one embodiment, film 1001 is utilized with a mobile phone, as shown above, wherein the film adheres directly onto a surface of the phone and prevents slipping of the phone when placed upon a relatively smooth surface of another structure, for example, a car dash or desktop surface.

In the contemplated embodiment, film 1001 preferably comprises of three layers: a first layer 1003 composed of an elastic material to prevent slipping; a second layer 1005 composed of an plastic material and configured to retain film 1001 in a dimensionally stable shape; and, an optional third layer 1007 disposed between the first layer and the second layer and adapted to display a graphical indicia, i.e., a company logo. In the preferred embodiment, film 1001 is very thin, preferably having a thickness “T” of no greater than about 0.032 inches.

The manufacturing process of bonding these layers can be achieved through one or more of processes already discussed herein. In one contemplated embodiment, a first adhesive 1009 is applied to a surface 1011 of second layer 1005 and a surface 1013 of third layer 1007, while a second adhesive 1015 is applied to a surface 1017 of third layer 1007 and a surface 1019 of first layer 1003. The adhesives are cured during the manufacturing process, which in turn securely bonds the layers to each other. It will be appreciated that alternative manufacturing processes could be utilized to secure the layers to each other, for example, sufficient heat could be utilized to thermally bond the layers together. Other similarly suitable bonding processes are also contemplated. These alternative manufacturing processes could potentially eliminate the need for an adhesive disposed between the layers.

A third adhesive 1021 is also utilized in the exemplary embodiment. Adhesive 1021 is applied to a surface 1023 of second layer 1005 and configured to removably attach film 1001 to the object, i.e., a mobile phone, attached thereto. An optional removable liner (not shown) can be utilized to protect adhesive 1021 from exposure.

Second layer 1005 is substantially similar to the plastic film substrate 15 discussed above. Specifically, second layer 1005 is preferably a thin, flexible plastic film, of about 0.002 inches thick that provides a flexible, durable, dimensionally stable substrate. Second layer 1005 preferably has a smooth surface finish, as may be attained with a co-extrusion process, and has a surface energy less than about 40 Dynes/cm. For aesthetic purposes, second layer 1005 may be tinted or may include embedded or printed graphical indicia.

Third layer 1007 is an optional layer disposed between first layer 1003 and second layer 1005, and is substantially similar to the label stock 51 discussed above. Third layer 1007 may include graphical and/or textual indicia or other desired items, which is visible through first layer 1003 and/or second layer 1005. Thus, the graphical indicia can be printed on either surface 1013 and/or surface 1017 of third layer 1007.

First layer 1003 is composed of an elastic material adapted to reduce slipping, as discussed above, yet is sufficiently formable during the manufacturing process to eliminate the use of a casting film. First layer 1003 is preferably composed of a thermoplastic elastomer (TPE) having a low durometer less than 40 on the Shore A scale. It should be understood that utilizing an elastic material with a higher durometer greatly reduces the efficiency of first layer 1003. Thus, the preferred embodiment incorporates a plastic film that has a surface energy less than about 40 Dynes/cm and a layer of TPE material having a durometer less than 40 on a Shore A scale.

The TPE material is preferably from a class of copolymers or a physical mix of polymers (usually a plastic and a rubber) which consist of materials with both thermoplastic and elastomeric properties. It should be understood that while most elastomers are thermosets, thermoplastics are in contrast relatively easy to use in manufacturing, for example, by injection molding. Thermoplastic elastomers show advantages typical of both rubbery materials and plastic materials.

There exist six generic classes of TPEs: Styrenic block copolymers; Polyolefin blends; Elastomeric alloys (TPE-v or TPV); Thermoplastic polyurethanes; Thermoplastic copolyester; and Thermoplastic polyamides. The TPE of the present application is capable of: stretching to a moderate elongation and, upon removal of the stress, return to something close to its original shape; is processable as a melt at elevated temperature; and, is devoid of significant creep.

Referring next to FIG. 11 in the drawings, the preferred method of manufacturing film 1001 is schematically illustrated. It should be appreciated that this method does not include the use of a casting means, such as a casting film 71, to transfer a textured and polished surface finish to first layer 1003. The texturing of the TPE layer is achieved through one or more rollers having a contoured surface area. These features are discussed in detail below.

The manufacturing process includes the step of applying TPE material, i.e., first layer 1003, to second layer 1005 or optional third layer 1007 already formed and wound together on roll 1101. A nozzle 1103 or similarly suitable means is utilized to apply the TPE material, preferably in liquid form, to the unwound second layer 1005.

First layer 1003 is preferably applied to second layer 1005 by pouring, spraying, spreading, doping, or any other conventional application means suitable for applying a TPE material to solid sheets or films. However, the preferred method of applying first layer 1003 to second layer 1005 is by controlled pouring in a continuous production process in which the TPE material is thereafter sandwiched between rollers 1105 and 1107 to create a textured and/or polished surface finish. Rollers 1105 and 1107 cause the TPE material to spread evenly at a selected thickness over second layer 1005. In the preferred embodiment, roller 1105 includes a contoured surface 1109 that creates a desired textured and/or polished surface finish of on surface 1025 of first layer 1003.

The next step includes the process of curing film 1001, which is indicated by area 1111. The curing process may include raised temperatures and pressures for varying durations of time. The specific temperatures, pressures, and cure times may vary depending upon the specific characteristics that are desired in the final film. It will be appreciated that other layers of materials, such as adhesives, label stocks, and release liners, may be added before or after the curing process. The desired TPE material may undergo the heat of the curing process without experiencing any undesirable changes in shape, dimensions, or composition.

Due to the thickness of second layer 1005, it is preferred that the layer be heat stabilized prior to use. This heat stabilization ensures that second layer 1005 can endure the heat cycle of the curing process without cockling or buckling. This prior heat stabilization of second layer 1005 is not typical of plastic films. Further, if third layer 1007 is utilized, the bonding and printing process is prepared prior to TPE material being applied. Once manufactured in sheet form, film 1001 may be configured for a wide variety of uses and applications, by cutting, shaping, and other post-processing steps.

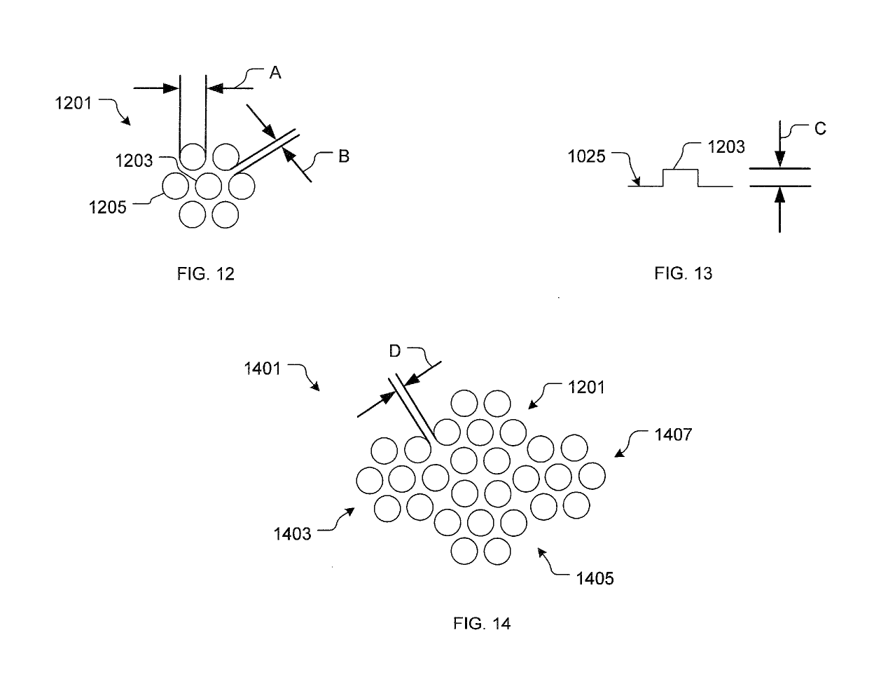

FIGS. 12-14 illustrate an optional surface treatment applied to surface 1025 of film 1001. In the preferred embodiment, a cluster 1201 of raised circular dimples is formed on surface 1025. It has been shown that the arrangement of dimples in this embodiment effectively reduces slipping.

Cluster 1201 preferable includes seven dimples, a raised center dimple 1203 equally surrounded by a six raised dimples 1205. Dimples 1203 and 1205 are preferably circular in profile with a diameter “A” of about 1.2 millimeters, spaced at an equal distance “B” of about 0.15 millimeters relative to each other, and having an elevated height “C” of about 0.15 millimeters relative to surface 1025. It has been shown that these dimensions provide the greatest efficiency; however, it should be appreciated that dimples 1203 and 1205 could have different shapes and dimensions in alternative embodiments. Alternative embodiments could include different surface treatments such as grooves, inwardly extending dimples, and/or other suitable contouring.

The preferred embodiment includes a plurality of clusters 1201 to form a surface treatment 1401. In the exemplary embodiment, surface treatment 1401 includes four clusters, namely, cluster 1201, cluster 1403, cluster 1405, and cluster 1407 tightly spaced together such that each dimple is spaced at an equal distance “D” of about 0.15 millimeters relative to each other. It should be understood that more or less clusters could be utilized in alternative embodiments, all depending on the desired surface treatment.

It is apparent that an invention with significant advantages has been described and illustrated. Although the present invention is shown in a limited number of forms, it is not limited to just those forms, but is amenable to various changes and modifications without departing from the spirit thereof.

What is claimed is:

1. An anti-slip film, comprising:
a dimensionally stable plastic film, having:
a first surface and a second surface;
a layer of thermoplastic elastomeric material bonded to the first surface; and
an adhesive applied to the second surface;
wherein the thermoplastic elastomeric material elastically deforms to prevent slipping; and
wherein the adhesive removably attaches to an object.

2. The anti-slip film of claim 1, wherein the plastic film has a surface energy of less than about 40 Dynes/cm.

3. The anti-slip film of claim 1, wherein the durometer of the thermoplastic elastomeric material is less than about 40 on the Shore A scale.

4. The anti-slip film of claim 1, wherein:
the plastic film has a surface energy of less than about 40 Dynes/cm; and
the durometer of the thermoplastic elastomeric material is less than about 40 on the Shore A scale.

5. The anti-slip film of claim 1, further comprising:
a surface treatment disposed on a first surface of the layer of thermoplastic material.

6. The anti-slip film of claim 5, wherein the surface treatment is a cluster of dimples.

7. The anti-slip film of claim 6, the cluster comprising:
a raised center dimple; and
six surrounding raised dimples;
wherein the center dimple and the six surrounding dimples extend from the first surface.

8. The anti-slip film of claim 7, wherein the center dimple and the six surrounding dimples are equally spaced apart from each other.

9. The anti-slip film of claim 7, wherein the center dimples and the six surrounding dimples have a diameter of about 1.2 millimeters and spaced at about 0.15 millimeters relative to each other.

10. A combination mobile phone and anti-slip film, comprising:
the mobile phone having a top surface; and
the anti-slip film, having:
a dimensionally stable plastic film having a first surface and a second surface;
a layer of elastic material bonded to the plastic film;
an adhesive applied to the second surface;
wherein the adhesive bonds to the top surface of the mobile phone; and
wherein the elastic material elastically deforms to prevent slipping of the mobile phone relative to a surface of a structure placed thereupon.

11. The combination mobile phone and anti-slip film of claim 10, wherein the elastic material is thermoplastic elastomeric material.

12. The combination mobile phone and anti-slip film of claim 10, further comprising:
a label stock disposed between the plastic film and the layer of elastic material;
wherein the label stock is visible through the layer of elastic material.

13. The combination mobile phone and anti-slip film of claim 10, further comprising:
a first adhesive disposed between the label stock and the plastic film; and
a second adhesive disposed between the label stock and the layer of elastic material.

14. The combination mobile phone and anti-slip film of claim 10, wherein the durometer of the elastic elastomeric material is less than about 40 on the Shore A scale.

15. The combination mobile phone and anti-slip film of claim 10, wherein:
the plastic film has a surface energy of less than about 40 Dynes/cm; and
the durometer of the elastic material is less than about 40 on the Shore A scale.

16. The combination mobile phone and anti-slip film of claim 10, further comprising:
a surface treatment disposed on a first surface of the layer of elastic material.

17. The combination mobile phone and anti-slip film of claim 16, wherein the surface treatment is a plurality of raised dimples.

18. A method to prevent slipping of an object relative to a structure, comprising:
providing an anti-slip film, having:
a layer of elastic material bonded to a dimensionally stable plastic film;
adhesively bonding the plastic film to the object; and
placing the object on the structure such that the layer of elastic material comes into contact with a surface of the structure;
wherein the elastic material elastically extends to prevent movement of the object relative to the structure.

19. The method of claim 18, further comprising:
securing the structure with a surface treatment on a surface of the elastic material.

20. The method of claim 19, further comprising:
securing the structure with a plurality of raised dimples.
